(19) United States
(12) Patent Application Publication
(10) Pub. No.: US 2018/0093313 A1
(43) Pub. Date: Apr. 5, 2018

(54) BACKPLATE MOLDING DEVICES AND METHODS FOR CURVED DISPLAYS

(71) Applicant: Shenzhen China Star Optoelectronics Technology Co. Ltd., Shenzhen, Guangdong (CN)

(72) Inventors: Yuchun HSIAO, Shenzhen, Guangdong (CN); Dehua LI, Shenzhen, Guangdong (CN); Gang YU, Shenzhen, Guangdong (CN); Chengwen QUE, Shenzhen, Guangdong (US)

(73) Assignee: Shenzhen China Star Optoelectronics Technology Co., Ltd., Shenzhen, Guangdong (CN)

(21) Appl. No.: 15/100,428

(22) PCT Filed: May 13, 2016
(86) PCT No.: PCT/CN2016/082060

§ 371 Date: May 31, 2016

(30) Foreign Application Priority Data
Apr. 20, 2016 (CN) 201610246348.8

(51) Int. Cl. B21D 22/06; B21D 37/10; B21D 37/08

(52) U.S. Cl. CPC B21D 22/06; B29L 2031/3475; B21D 37/08; B21D 37/10

(57) ABSTRACT

A backplate molding device includes a top mold and a down mode. The top mold includes a plurality of punching heads having curved operation surfaces and a pressure plate. The punching heads are arranged in multi-sections and the pressure plate is arranged at a lateral side of the punching heads in the multi-section. An operation surface of the down mold is a curved surface engageable with the operation surfaces of the punching heads in the multi-section, and edges of the down mold cooperatively engages with the pressure plate to fix backplate materials. A punching process is applied toward the backplate material by bonding the operation surface of the punching heads with the operation surface of the down mold in sequence to plastically deform the backplate materials. The present disclosure also relates to a backplate molding method.

### CROSS REFERENCE

This application claims the priority of Chinese Patent Application No. 201610246438.8, entitled “Backplate molding devices and methods for curved displays”, filed on Apr. 20, 2016, the disclosure of which is incorporated herein by reference in its entirety.

### FIELD OF THE INVENTION

The present invention relates to a display technology field, and more particularly to a backplate molding device and a plate molding method for curved displays.

### BACKGROUND OF THE INVENTION

With the development of display technology, super thin design has been a trend of curved displays. Usually, the curved display includes a backplate, a backlight unit, and a display panel. The backlight unit and the display panel are fixed on the backplate in a predetermined curved state so as to be the same curved as the backplate. Thus, it is important to design and manufacture the backplate to be as light and thin as possible while the curved state is maintained.

Currently, the backplate molding method relates to adopting punching molding device having male die and female die to perform disposal metal forming. A middle portion of the backplate is formed with a bent convex hull via plastic deformation so as to obtain an ideal curvature of the curved backplate. With respect to large-scale backplate, a huge bent convex hull is formed by the disposal metal forming, which requires a punching machine of high tonnage. In addition, as the workpiece is thinner, the workpiece may be damaged due to non-uniform stretch, which results in a low yield rate.

### SUMMARY OF THE INVENTION

The present disclosure relates to a backplate molding device and molding method of curved backplate to resolve the above problems.

In one aspect, a backplate molding device for curved displays includes: a top mold and a down mode, the top mold includes a plurality of punching heads having curved operation surfaces and a pressure plate, the punching heads are arranged in multi-sections and the pressure plate is arranged at a lateral side of the punching heads in the multi-section, an operation surface of the down mold is a curved surface engageable with the operation surfaces of the punching heads in the multi-section, edges of the down mold cooperatively engages with the pressure plate to fix backplate materials, a punching process is applied toward the backplate material by bonding the operation surface of the punching heads with the operation surface of the down mold in sequence to plastically deform the backplate materials.

Wherein the operation surfaces of the punching head in multi-sections cooperatively define the operation surface of the top mold, and a degree of arc of the operation surface of the top mold is the same with that of the operation surface of the down mold.

Wherein the punching head in multi-sections are arranged symmetrically along a direction from a middle portion of the top mold to two lateral sides.

Wherein the pressure plate is configured with compressing protrusions, and edges of the down mold are configured with compressing slots, the compressing protrusion and the compressing slot are bonded together to compress two ends of backplate material.

Wherein a cross-section of the compressing protrusion is rectangular.

Wherein a cross-section of the compressing protrusion is arc-shaped.

Wherein the pressure plate is configured with compressing slots, and edges of the down mold are configured with compressing protrusions, the compressing protrusion and the compressing slot are bonded together to compress two ends of backplate material.

Wherein a cross-section of the compressing protrusion is rectangular.

Wherein a cross-section of the compressing protrusion is arc-shaped.

Wherein a slider structure is respectively arranged between two adjacent punching heads and between the first punching head and the pressure plate, and the punching heads in each of the sections slides with respect to each other to conduct the punching process.

Wherein the punching heads in multi-sections are made by quick-cutting steel or tungsten-steel.

In another aspect, a backplate molding method for curved displays includes: providing a backplate molding device for curved displays, the backplate molding device includes a top mold and a down mode, the top mold includes a plurality of punching heads having curved operation surfaces and a pressure plate, the punching heads are arranged in multi-sections and the pressure plate is arranged at a lateral side of the punching heads in the multi-section, an operation surface of the down mold is a curved surface engageable with the operation surfaces of the punching heads in the multi-section; arranging backplate materials between the top mold and the down mold of the backplate molding device; applying a punching process toward the backplate materials by the punching heads in the multi-sections; and trimming, convex shaping, punching, pressing deburring, and bending deformation to manufacture the backplate.

Wherein the pressure plate is configured with compressing protrusions, and edges of the down mold are configured with compressing slots, the compressing protrusion and the compressing slot are bonded together to compress two ends of backplate material so as to arrange the backplate materials between the top mold and the down mold of the backplate molding device.

Wherein the step of applying a punching process toward the backplate materials by the punching heads in the multi-sections further includes: controlling a degree of arc of the punching heads in multi-sections by configuring a curvature of operation surfaces of each of the punching heads in the multi-sections.

Wherein the backplate sheet is a planar and thin sheet.

In view of the above, as the plastic deformation and hardening processes are applied to the backplate, the strength of the backplate ensured while the backplate is thin. Also, the curved surface of the backplate is precise. In addition, the punching heads may independently conduct the punching process to greatly reduce the single-time punching dimension, which reduces the demands toward the punching machine of high tonnage. Further, the flow of the workpieces may be easily controlled, and the workpieces are prevented from being damaged for the reason that the workpiece may be uniformly stretched. The curvature of each of the punching heads may be controlled to realize the degree of the arc of each of the punching heads, which contributes to the adjustment of the workpiece and the molding device.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view of the backplate molding device of curved displays in accordance with a first embodiment.

FIG. 2 is a schematic view of step 1 of the backplate molding method of curved display in accordance with the first embodiment.

FIGS. 3-5 are schematic views of step 2 of the backplate molding method of curved display in accordance with the first embodiment.

FIG. 6 is a schematic view of the backplate molding device of curved displays in accordance with a second embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

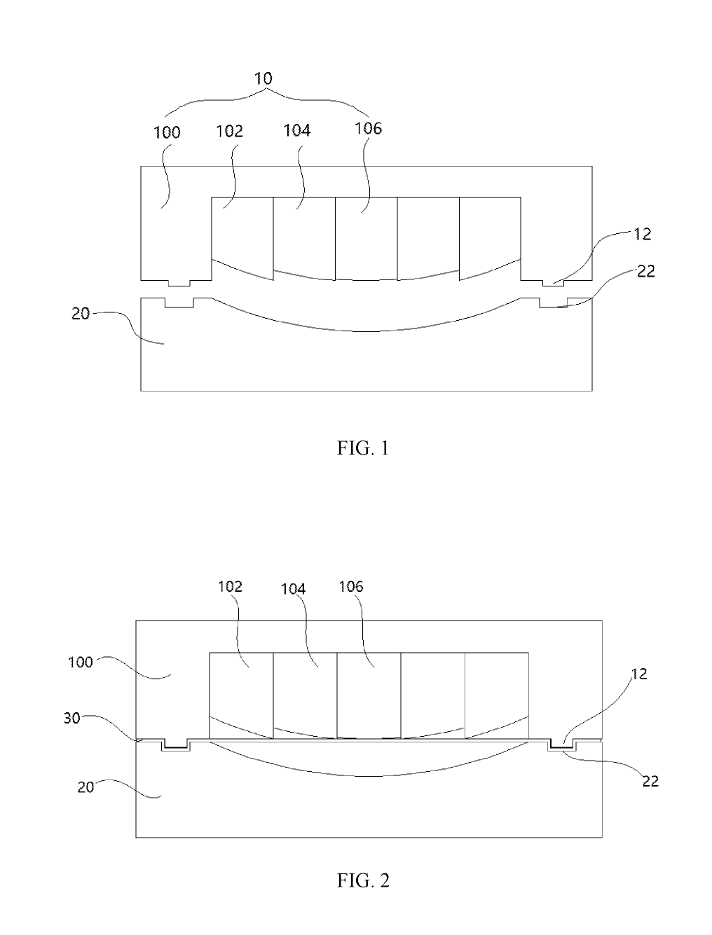

FIG. 1 is a schematic view of the backplate molding device of curved displays in accordance with a first embodiment. As shown, the device includes a top mold 10 and a down mold 20. The top mold 10 includes a third punching head 106, two second punching heads 104, and two first punching heads 102 arranged along a direction from a middle portion to two lateral sides, and a pressure plate 100. A slider structure is respectively arranged between two adjacent punching heads and between the first punching head 102 and the pressure plate 100, such that the first punching heads 102, the second punching head 104, and the third punching head 106 may slide with respect to each other along a punching direction. In addition, the punching heads may independently conduct the punching process to greatly reduce the single-time punching dimension, which reduces the demands toward the punching machine of high tonnage.

The operation surfaces of each of the punching heads are curved. The operation surfaces of each of the punching heads cooperatively form the operation surface of the top mold 10. The operation surface of the top mold 10 corresponds to the arc-shaped operation surface of the down mold 20, and degrees of the arc of the operation surfaces of the top mold 10 and the down mold 20 are the same. The degree of the arc corresponding to different sections may be controlled by configuring the curvature of the operation surfaces of the punching heads in different sections.

The pressure plate 100 includes at least one compressing protrusion 12 having a rectangular-shaped cross-section. The down mold 20 includes at least one corresponding compressing slot 22. The compressing protrusion 12 and the compressing slot 22 are bonded together to compress two ends of backplate material 30 such that a middle portion of the backplate material 30 is plastically deformed when the operation surface of the top mold 10 is adhered to the operation surface of the down mold 20.

In view of the above, the backplate molding device includes a plurality of punching heads arranged in different sections. Thus, the punching machine of high tonnage is not necessary. The workpiece may be easily controlled so as to be uniformly stretched. The backplate material 30 may not be damaged when the thickness of the backplate material 30 is thinner, and the strength of the backplate may be the same when the predetermined curvature remains.

Referring to FIGS. 2-5, the backplate molding method includes the following steps.

In step 1, the sheet-shaped backplate material 30 is arranged between the top mold 10 and the down mold 20. By engaging the compressing protrusion 12 of the pressure plate 100 and the compressing slot 22 of the down mold 20, two ends of the backplate material 30 are compressed such that the middle portion of the backplate material 30 may be plastically deformed by punching processes.

In one embodiment, the cross-section of the compressing protrusion 12 is rectangular. By engaging the compressing protrusion 12 of the pressure plate 100 and the compressing slot 22 of the down mold 20, two ends of the backplate material 30 are compressed. In another example, the cross-section of the compressing protrusion 12 may be arc-shaped or other shapes that can be engageable with the compressing slot 22.

In step 2, the punching process is applied to the backplate material 30 by the punching heads in each of the sections in sequence, such that the middle portion of the backplate material 30 may be plastically deformed to obtain the predetermined curvature.

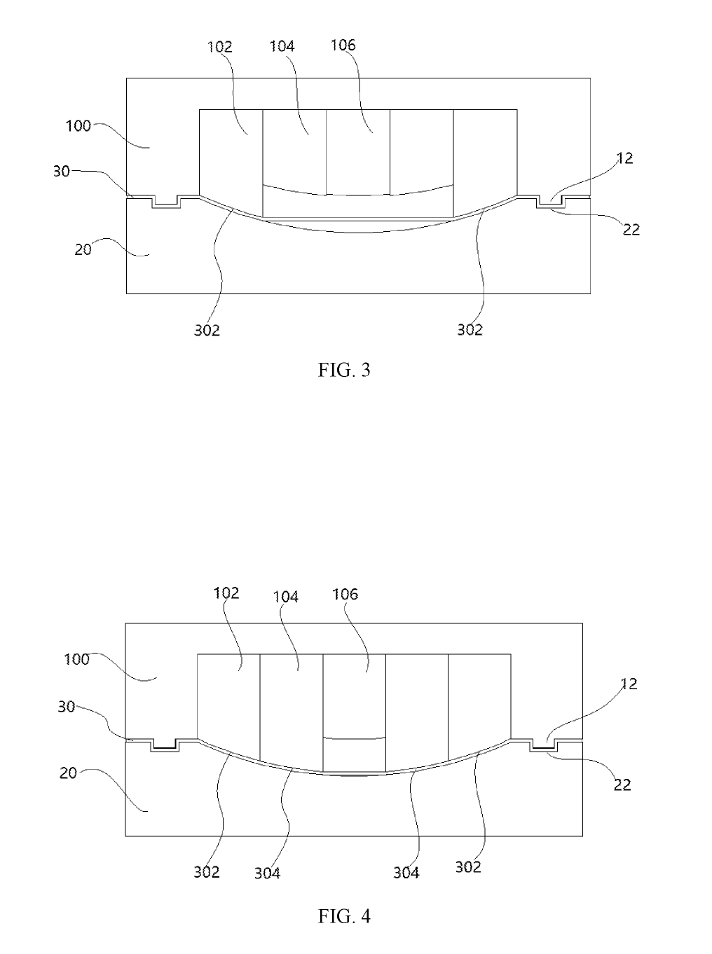

Referring to FIG. 3, the two symmetrically arranged first punching heads 102 are adopted to conduct the first punching process toward the backplate material 30. The operation surface of the first punching heads 102 engages with the operation surface of the down mold 20. The first portion 302 of the backplate material 30 corresponding to the operation surface of the first punching heads 102 is plastically deformed to obtain the predetermined curvature.

Referring to FIG. 4, the two symmetrically arranged second punching heads 104 are adopted to conduct the second punching process toward the backplate material 30. The operation surface of the second punching heads 104 engages with the operation surface of the down mold 20. The second portion 304 of the backplate material 30 corresponding to the operation surface of the first punching heads 102 is plastically deformed to obtain the predetermined curvature.

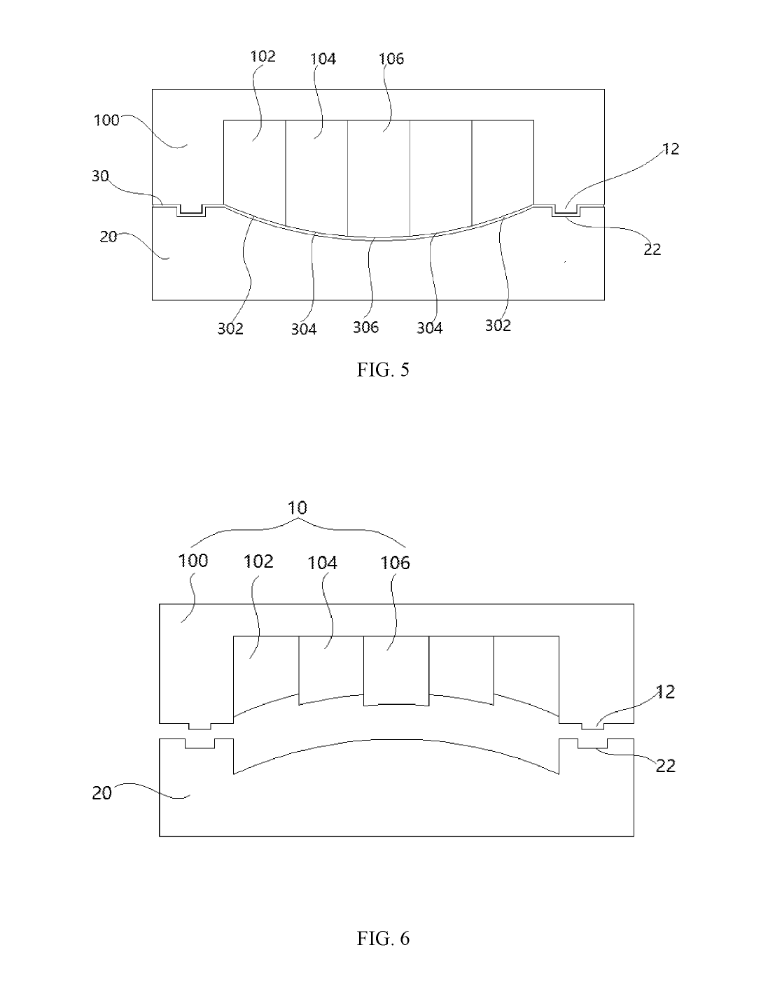

Referring to FIG. 5, the third punching head 106 is adopted to conduct the third punching process toward the backplate material 30. The operation surface of the third punching heads 106 engages with the operation surface of the down mold 20. The third portion 306 of the backplate material 30 corresponding to the operation surface of the third punching heads 106 is plastically deformed to obtain the predetermined curvature.

The degree of the arc of the first portion 302, the second portion 304, and the third portion 306 of the backplate material 30 may be respectively controlled by configuring the curvatures of the first punching heads 102, the second punching heads 104, and the third punching head 106, which contributes to adjustments toward workpieces and molding device. The punching dimension of single-time punching may be greatly reduced by adopting the multi-section punching configuration. The workpiece may be easily controlled so as to be uniformly stretched, and thus the workpieces are prevented from being damaged during the punching process.

In step 3, the backplate material 30 is taken out after the punching process is completed. Afterward, trimming, convex shaping, punching, pressing deburring, and bending deformation are applied to the backplate so as to complete the manufacturing process.

After the curved surface of the backplate is formed, the processes, such as trimming, convex shaping, punching, pressing deburring, and bending deformation, are applied to ensure the stability of the assembly of the curved backplate, the backlight unit, and the display panel so as to reduce the assembly complexity of the curved displays.

In view of the above, the backplate molding method conducts the punching process by a plurality punching heads in different sections. The punching dimension of single-time punching may be greatly reduced by adopting the multi-section punching configuration. The workpiece may be easily controlled so as to be uniformly stretched. In addition, plastic deformation and hardening processes are applied to the backplate, which ensures the strength of the backplate.

FIG. 6 is a schematic view of the backplate molding device of curved displays in accordance with a second embodiment. The difference between the first embodiment and the second embodiment resides in that: in the second embodiment, the operation surfaces of the first punching heads 102, the second punching heads 104, and the third punching head 106 are concave, and the operation surface of the down mold 20 is convex. The multi-section punching is conducted by the third punching head 106, the second punching head 104, and the first punching head 102 in sequence. The plastic deformation is applied along a direction from the middle portion to the lateral sides. The rigidity and strength of the curved backplate is ensured, and also the precise curved surface.

Above are embodiments of the present invention, which does not limit the scope of the present invention. Any modifications, equivalent replacements or improvements within the spirit and principles of the embodiment described above should be covered by the protected scope of the invention.

1. A backplate molding device for curved displays, comprising:
a top mold and a down mode, the top mold comprises a plurality of punching heads having curved operation surfaces and a pressure plate, the punching heads are arranged in multi-sections and the pressure plate is arranged at a lateral side of the punching heads in the multi-section, an operation surface of the down mold is a curved surface engageable with the operation surfaces of the punching heads in the multi-section, edges of the down mold cooperatively engages with the pressure plate to fix backplate materials, a punching process is applied toward the backplate material by bonding the operation surface of the punching heads with the operation surface of the down mold in sequence to plastically deform the backplate materials.

2. The backplate molding device as claimed in claim 1, wherein the operation surfaces of the punching head in multi-sections cooperatively define the operation surface of the top mold, and a degree of arc of the operation surface of the top mold is the same with that of the operation surface of the down mold.

3. The backplate molding device as claimed in claim 1, wherein the punching head in multi-sections are arranged symmetrically along a direction from a middle portion of the top mold to two lateral sides.

4. The backplate molding device as claimed in claim 1, wherein the pressure plate is configured with compressing protrusions, and edges of the down mold are configured with compressing slots, the compressing protrusion and the compressing slot are bonded together to compress two ends of backplate material.

5. The backplate molding device as claimed in claim 4, wherein a cross-section of the compressing protrusion is rectangular.

6. The backplate molding device as claimed in claim 4, wherein a cross-section of the compressing protrusion is arc-shaped.

7. The backplate molding device as claimed in claim 1, wherein the pressure plate is configured with compressing slots, and edges of the down mold are configured with compressing protrusions, the compressing protrusion and the compressing slot are bonded together to compress two ends of backplate material.

8. The backplate molding device as claimed in claim 7, wherein a cross-section of the compressing protrusion is rectangular.

9. The backplate molding device as claimed in claim 7, wherein a cross-section of the compressing protrusion is arc-shaped.

10. The backplate molding device as claimed in claim 1, wherein a slider structure is respectively arranged between two adjacent punching heads and between the first punching head and the pressure plate, and the punching heads in each of the sections slides with respect to each other to conduct the punching process.

11. The backplate molding device as claimed in claim 1, wherein the punching heads in multi-sections are made by quick-cutting steel or tungsten-steel.

12. A backplate molding method for curved displays, comprising:
providing a backplate molding device for curved displays, the backplate molding device comprises a top mold and a down mode, the top mold comprises a plurality of punching heads having curved operation surfaces and a pressure plate, the punching heads are arranged in multi-sections and the pressure plate is arranged at a lateral side of the punching heads in the multi-section, an operation surface of the down mold is a curved surface engageable with the operation surfaces of the punching heads in the multi-section;
arranging backplate materials between the top mold and the down mold of the backplate molding device;
applying a punching process toward the backplate materials by the punching heads in the multi-sections; and
trimming, convex shaping, punching, pressing deburring, and bending deformation to manufacture the backplate.

13. The backplate molding method as claimed in claim 12, wherein the pressure plate is configured with compressing protrusions, and edges of the down mold are configured with compressing slots, the compressing protrusion and the compressing slot are bonded together to compress two ends of backplate material so as to arrange the backplate materials between the top mold and the down mold of the backplate molding device.

14. The backplate molding method as claimed in claim 12, wherein the step of applying a punching process toward the backplate materials by the punching heads in the multi-sections further comprises: controlling a degree of arc of the punching heads in multi-sections by configuring a curvature of operation surfaces of each of the punching heads in the multi-sections.

15. The backplate molding method as claimed in claim 12, wherein the backplate sheet is a planar and thin sheet.
